(19) United States
(12) Patent Application Publication
(10) Pub. No.: US 2008/0231459 A1
(43) Pub. Date: Sep. 25, 2008

(54) Cargo Container Monitoring Device

(75) Inventor: Rodney Corder, Chesterton, IN (US)

Correspondence Address: Law Offices of Tim Headley, 7941 Katy Fwy, Suite 506, Houston, TX, 77024-1924, US

(73) Assignee: Container Trac, LLC, Dana Point, CA (US)

(21) Appl. No.: 12/131,010

(22) Filed: May 30, 2008

Related U.S. Application Data
(63) Continuation of application No. 11/690,543, filed on Mar. 23, 2007.

(51) Int. Cl. G08B 13/14

(52) U.S. Cl. 340/572.7

(57) ABSTRACT

According to one embodiment, a cargo container monitoring system includes components located on a cargo ship for collecting cargo container status information for a plurality of cargo containers. The components include at least one combination data logger and gateway device. The combination device includes a first antenna and a second antenna. The first antenna is configured to receive first wireless communications signals transmitted by a plurality of tags at a first frequency. Each tag is associated with a particular one of the cargo containers and the first wireless communications signals received from each tag include cargo container status information for the associated cargo container. The second antenna is configured to transmit second wireless communications signals to an access point at a second frequency. The second wireless communications signals include the cargo container status information received from the plurality of tags and the first frequency is different from the second frequency.

### CROSS-REFERENCE TO RELATED APPLICATIONS

This application is a continuation of U.S. application Ser. No. 11/690,543, filed Mar. 23, 2007.

### STATEMENT REGARDING FEDERALLY SPONSORED RESEARCH OR DEVELOPMENT

Not Applicable.

### REFERENCE TO A “SEQUENTIAL LISTING,” A TABLE, OR A COMPUTER PROGRAM LISTING APPENDIX SUBMITTED ON A COMPACT DISC

Not Applicable.

### BACKGROUND OF THE INVENTION

1. Field of the Invention

The present invention relates generally to data collection and more particularly to cargo container monitoring systems.

2. Description of Related Art

In a global economy, products and goods are shipped throughout the world via, trucks, trains, planes, ships, etc. Such products and goods are often containerized for shipping by packing the products and goods into containers that may be sealed by the manufacturer or producer prior to shipping and then opened at a final or intermediary destination. Such containers may for example be loaded onto a truck for delivery to a port, loaded onto a cargo ship, carried to a destination port, loaded onto a train, and unloaded at a final or intermediary destination, such as a foreign distributor of such products or goods. The contents, origin, destination, and history of such containers is often recorded and maintained in documents and/or electronically for use by the manufacturer or producer, the shipping company, the distributor, and/or regulatory agencies. However, determining the condition of a particular container and/or the contents of a particular container prior to its arrival at its final destination often requires a person or persons to physically inspect the container and/or its contents.

### SUMMARY OF THE INVENTION

In accordance with the present invention, a cargo container monitoring system is provided. Embodiments of the invention may allow a system user to remotely monitor the status of cargo containers throughout the world. Such monitoring may occur in substantially real-time, such that a system user may be informed of a change in the status of a cargo container shortly after that change occurs. For example, embodiments of the invention may allow a system user to be informed of a breach of a cargo container while the cargo container is being shipped on a truck, train, or cargo ship. Embodiments of the invention may materially contribute to countering terrorism by providing information about cargo containers being shipped into the United States, prior to their arrival at a United States port. In addition, embodiments of the invention may allow regulatory agents to target particular cargo containers for inspection upon arriving in port based on remotely collected status information about those particular cargo containers. As another example, embodiments of the invention may reduce shipping costs by improving the security of cargo containers during their shipment by providing substantially real-time status information when the security or integrity of the cargo containers is compromised. As yet another example, embodiments of the invention may provide a system user with information regarding whether a cargo container has been handled properly during shipment.

According to one embodiment, a cargo container monitoring system includes components located on a cargo ship for collecting cargo container status information for a plurality of cargo containers. The components include at least one combination data logger and gateway device. The combination device includes a first antenna and a second antenna. The first antenna is configured to receive first wireless communications signals transmitted by a plurality of tags at a first frequency. Each tag is associated with a particular one of the cargo containers and the first wireless communications signals received from each tag include cargo container status information for the associated cargo container. The second antenna is configured to transmit second wireless communications signals to an access point at a second frequency. The second wireless communications signals include the cargo container status information received from the plurality of tags and the first frequency is different from the second frequency.

According to another embodiment, a cargo container monitoring device for collecting cargo container status information for a plurality of cargo containers aboard a cargo ship includes a first antenna, a memory, a second antenna, and a processor. The first antenna is configured to receive first wireless communications signals transmitted by a plurality of tags at a first frequency. Each tag is associated with a particular one of the cargo containers and the first wireless communications signals received from each tag include cargo container status information for the associated cargo container. The memory is configured to store the cargo container status information received from the plurality of tags. The second antenna is configured to transmit second wireless communications signals to an access point at a second frequency, the second wireless communications signals including the cargo container status information received from the plurality of tags. The processor is configured to control the operation of the device and the first frequency is different from the second frequency.

According to another embodiment, a method for monitoring a plurality of cargo containers includes receiving at a terminal, cargo container status information for a plurality of cargo containers aboard a cargo ship and displaying at the terminal, a graphical user interface including at least a portion of the cargo container status information for the plurality of cargo containers aboard the cargo ship. The received cargo container status information having been collected by a combination data logger and gateway device. The combination device including a first antenna and a second antenna. The first antenna is configured to receive first wireless communications signals transmitted by a plurality of tags at a first frequency. Each tag is associated with a particular one of the plurality of cargo containers and the first wireless communications signals received from each tag include cargo container status information for the associated cargo container. The second antenna is configured to transmit second wireless communications signals to an access point at a second frequency. The second wireless communications signals include the cargo container status information received from the plurality of tags and the first frequency is different from the second frequency.

Embodiments of the invention provide various technical advantages. For example, these systems may allow cargo container status information to be transmitted on a periodic basis, in response to a request, and/or upon detection of a triggering event. As another example, these systems may allow for the collection of status information for cargo containers distributed throughout a cargo ship without requiring excessive power sources to be provided in proximity to those containers. As another example, these systems may allow for the collection of cargo container status information at a centralized location without requiring an extensive infrastructure of communications cables extended from a ships tower to the cargo deck.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIGS. 1A and 1B illustrate an example embodiment of a cargo container monitoring system;

FIG. 2 illustrates an example cargo ship including components of an example cargo container monitoring system;

FIG. 3A illustrates example cargo containers, each with a tag mounted on the cargo container door and in communication with an example data logger;

FIG. 3B illustrates an example embodiment of a tag for use with an example cargo container monitoring system;

FIG. 4 illustrates an example data flow between a plurality of tags and components of an example cargo container monitoring system;

FIGS. 5A and 5B illustrate example data loggers for use with an example cargo container monitoring system;

FIG. 6 illustrates an example gateway device for use with an example cargo container monitoring system;

FIG. 7 illustrates an example configuration of elements within a cargo container monitoring system;

FIG. 8 is a block diagram illustrating functional components of a controller for use with an example cargo container monitoring system; and

FIGS. 9A-9C illustrate example graphical user interfaces for use with an example cargo container monitoring system.

### DETAILED DESCRIPTION OF EXAMPLE EMBODIMENTS

It should be understood at the outset that although example implementations of embodiments of the invention are illustrated below, the present invention may be implemented using any number of techniques, whether currently known or not. The present invention should in no way be limited to the example implementations, drawings, and techniques illustrated below. Additionally, the drawings are not drawn to scale.

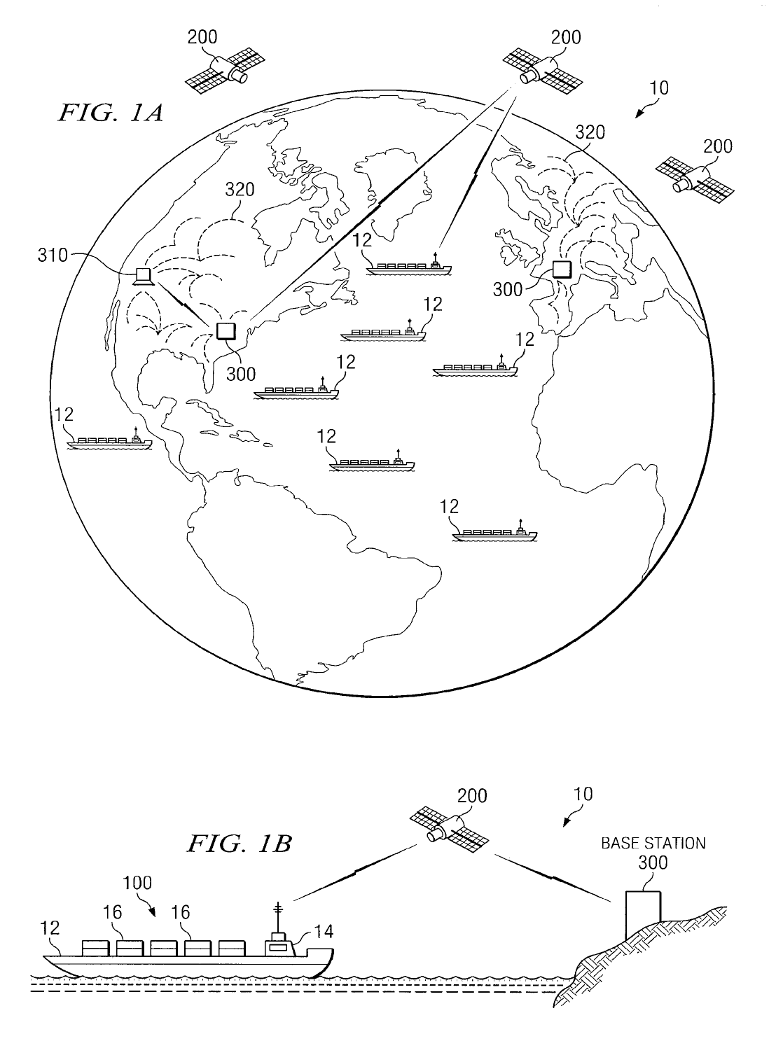

FIGS. 1A and 1B illustrate example implementations of a cargo container monitoring system. As shown in FIG. 1A, a cargo container monitoring system, indicated generally at 10, may be utilized to monitor cargo containers on a plurality of ships 12. For example, as shown in FIGS. 1A and 1B, cargo data may be transmitted from one or more ships 12 to base station 300 via one or more satellites 200. As another example, cargo data may be transmitted from one or more ships 12 to base station 300 via a local or wide area wireless or wireline network while ship 12 is in port. As yet another example, cargo data may be transmitted from a warehouse, a train, or a truck while cargo containers are being stored and/or shipped on land. This data may be received via any suitable wireless or wireline network, including but not limited to, satellite networks, cellular networks, IEEE 802.11 networks, etc. This data may then be transmitted from base station 300 to one or more terminals 310 through one or more networks 320. Certain embodiments of cargo container monitoring system 10 may be helpful to improve the efficiency of worldwide freight shipping, to improve port security, and/or to reduce losses due to theft.

Once implemented, certain embodiments of cargo container monitoring system 110 may materially contribute to countering terrorism. In January of 2002, U.S. Customs Commissioner, Robert c. Bonner proposed the U.S. Customs Container Security Initiative (CSI), as an approach to secure ocean going sea containers. As proposed, the CSI consisted of four core elements: “(1) establishing security criteria to identify high-risk containers; (2) pre-screening containers before they arrive at U.S. ports; (3) using technology to pre-screen high-risk containers; and (4) developing and using smart and secure containers.” In October 2003, Commissioner Bonner stated that the first three elements of CSI were operational in protecting America, but that the fourth “core element” of container security had “lagged behind the other three in development.” According to Commissioner Bonner, “the best factory and loading dock security at the point of stuffing of a container, the best CBP targeting, and the best CSI inspections are part of the solution, but after all has been done, a terrorist must not be able to open a container in route and stuff a bomb in it, or weapon of mass destruction (WMD). We should know if there has been unauthorized entry along the supply chain.” In December 2006, the Commissioner of U.S. Customs and Border Protection, W. Ralph Basham, discussed a newly announced Secure Freight Initiative which “envisions a private sector-based approach to obtaining information on global cargo movements, beyond currently regulated submissions.”

Certain embodiments of custom cargo container system 10 may address one or more of these concerns expressed by these U.s. Customs Commissioners and/or assist in providing the technology needed to enable these initiatives. For example, cargo container monitoring system 10 may provide an improved global cargo tracking system and provide substantially real time alerts if one or more cargo containers has been opened and/or breached before arriving at a United States port. As another example, cargo container monitoring system 10 may provide port authorities with information regarding hazardous materials, unauthorized radioactive materials, illegal aliens, or other concerning cargo within one or more cargo containers destined for a United States port.

Cargo container monitoring system 10 may be used to collect data from or about cargo containers and their cargo at any point along a shipping route or while in storage. For example, cargo container monitoring system 10 may be used to monitor cargo containers as they travel by truck, by train, and/or by ship 12. Once a cargo container has been loaded onto a ship 12, cargo container monitoring system 10 may collect and distribute data relating to that cargo container while the ship is still at port or while the ship is at sea. New data collected by cargo container monitoring system 10 may include information about the location of particular cargo containers, information about the security of particular cargo containers, and/or information about internal and/or external characteristics of a particular cargo container. For example, cargo container monitoring system 10 may collect data about the temperature, humidity, or pressure within a cargo container. As another example, cargo container monitoring system 10 may collect data about whether or not a door and/or seal to a particular cargo container has been breached. In particular embodiments, cargo container monitoring system 10 may collect data to determine the presence of radioactive materials, explosive materials, and/or hazardous chemicals within a particular cargo container.

Ship 12 represents any appropriate vessel for carrying one or more cargo containers between two destinations over one or more bodies of water. Cargo container 16 represents any appropriate container for carrying cargo on ship 12. In certain embodiments, cargo container 16 may represent a standard forty-foot box-type ISO container.

Tag 20 may represent a device configured to collect and transmit information about the condition of a cargo container 16 and/or cargo within a cargo container 16. In certain embodiments, tag 20 may include an internal power supply, one or more sensors, memory, a processor, and one or more antennas. In certain embodiments, tag 20 may be configured to transmit low power wireless signals at radio frequencies. Although any appropriate frequency may be used, in particular embodiments, tag 20 may transmit communication signals in the UHF band at a frequency of approximately 433 MHz, approximately 868 MHz, or approximately 915 MHz. In certain embodiments, tag 20 may include one or more sensors for detecting temperature, humidity, air pressure, radiation, motion, voltage, the presence of one or more chemicals, location (e.g., via GPS), etc. For example, tag 20 may include a thermocouple and/or one or more accelerometers.

In certain embodiments, tag 20 may be configured to detect a breach in cargo container 16 whether in the form of an opening in a door to cargo container 16 or otherwise. In certain embodiments, tag 20 may detect a breach in cargo container 16 using, for example, a loop seal or a magnetic switch. In certain embodiments, tag 20 may provide both visual and electronic evidence that a particular cargo container 16 has been breached. Such evidence may improve cargo security and confidence that cargo will arrive at its destination undisturbed.

In certain embodiments, tag 20 may store a unique serial number and may be 30 programmed for one-time activation upon sealing of cargo container 16. In certain embodiments, tag 20 may store information relating to a device or associated user that activates tag 20 upon scaling of cargo container 16. For example, the identity of a trusted sealing agent, such as a customs official or a shipping official may be maintained within the memory of tag 20. In certain embodiments, once tag 20 has been activated, any breach of cargo container 16 or other triggering event may cause tag 20 to actively transmit wireless data indicating such breach or other triggering event and/or cause tag 20 to indicate visually that the breach or other triggering event has occurred. In a particular embodiment, tag 20 may represent an i-Q or i-Q32T series tag available from IDENTEC SOLUTIONS INC., of Addison, Tex.

Satellite 200 may represent any appropriate orbiting telecommunications satellite. In certain embodiments, satellite 200 may include one or more antennas to transmit and receive communications signals. In various embodiments, satellite 200 may be configured to transmit and/or receive communications signals using one or more of code division multiple access (CDMA), frequency division multiple access (FDMA), and time division multiple access (TDMA) technologies. In a particular embodiment, satellite 200 may represent a government owned or commercially operated geosynchronous telecommunications satellite.

Although in various embodiments satellite 200 may include one or more antennas configured to transmit and receive any appropriate communications signals, in certain embodiments, satellite 200 may include one or more antennas configured to transmit and receive communications signals in the microwave band. For example, satellite 200 may include one or more antennas configured to transmit and receive communications signals in the range from 300 MHz to 30 GHz. In certain embodiments, satellite 200 may include one or more antennas configured to transmit and receive communications signals in one or more of the L, C, X, Ku, Ka, and S bands.

In certain embodiments, satellite 200 may be configured to transmit communications signals at frequencies in the range from 1500 MHz to 1600 MHz, and more particularly in the range from 1525 MHz to 1559 MHz. As one alternative, satellite 200 may be configured to transmit communications signals at frequencies in the range from 1600 MHz to 1700 MHz, and more particularly in the range from 1610 MHz to 1626.5 MHz.

In certain embodiments, satellite 200 may be configured to receive communications signals at frequencies in the range from 1600 MHz to 1700 MHz, and more particularly in the range from 1610 MHz to 1626.5 MHz or 1626.5 MHz to 1660.5 MHz. As one alternative, satellite 200 may be configured to receive communications signals in the range from 2400 MHz to 2500 MHz, and more particularly in the range from 2480 MHz to 2500 MHz.

Base station 300 represents an antenna, together with the necessary components needed to send and/or receive communications signals to and/or from one or more satellites 200. In certain embodiments, base station 300 may be coupled to network 320 and may communicate via network 320 with one or more terminals 310. In certain embodiments, base station 300 may include one or more servers or other data storage devices to aggregate data collected from a plurality of cargo containers 16. In certain embodiments, base station 300 may include one or more processors operable to process the collected data and to associate selected portions of the collected data for a particular end user. For example, selected portions of the collected data may be associated with a particular company, department, region, country, or cargo type.

Terminal 310 represents a hardware device capable of transmitting and/or receiving communications through network 320. Terminal 310 may represent a portable or fixed location device capable of transmitting and/or receiving communications through one or more appropriate wireless or wireline protocols. For example, terminal 310 may represent a cell phone, a personal digital assistant (FDA), a laptop or tablet computer, a desktop computer, etc. Additionally, terminal 310 may connect using one or more mobile communications technology such as global systems for mobile communications (GSM) and/or code division multiple access (CDMA). Furthermore, terminal 310 may support packet-based protocols such as Internet protocol (IP) and wireless standards such as the IEEE 802.11 family of wireless standards.

Network 320 represents communication equipment, including hardware and any appropriate controlling logic for interconnecting elements coupled to network 320. Thus, network 320 may represent a local area network (LAN), a metropolitan area network (MAN), a wide area network (WAN), and/or any other appropriate form of network. For example, network 320 may represent the Internet. Network 320 may include network elements such as routers, switches, converters, hubs, and splitters. Furthermore, elements within network 320 may utilize circuit-switched and/or packetbased communication protocols to provide for network services. For example, elements within network 320 may utilize Internet protocol (IP). In addition, elements within network 320 may utilize wireless standards such as the IEEE 802.11 family of wireless standards. As illustrated, network 320 may couple at least one base station 300 to at least one terminal 310.

In operation, cargo container monitoring system 10 may allow for continuous, or substantially continuous, monitoring of cargo containers 16 anywhere in the world, including while at sea. Cargo container monitoring system 10 may allow an end user to monitor a cargo container 16 from terminal 310 that may be hundreds or even thousands of miles away from the cargo container 16 being monitored. For example, a company, or a third party acting on behalf of a company, may monitor in substantially real-time the location and/or condition of numerous cargo containers 16 carrying that company's goods anywhere in the world. This information may be continuously updated, updated on a periodic basis, or updated upon the occurrence of a triggering event. Although any appropriate triggering event may be used, example triggering events may include a breach of one or more cargo containers 16, one or more cargo containers being outside of a specified criteria range (e.g., elevated temperature, elevated pressure, elevated humidity, etc.), arrival at a defined location such as a destination port, and/or deviation from a defined travel route. In certain embodiments, an alert may be generated and transmitted in response to the detection of a triggering event. Example alerts may include e-mail messages, SMS messages, etc. In certain embodiments, cargo container monitoring system 10 may provide significant savings in insurance premiums for ship owners and/or their customers by dramatically improving cargo container security, reliability, and safety.

In certain embodiments, communicated data, containing information about the cargo container, may be encrypted to ensure confidentiality and/or security. A multilevel encryption system may be utilized, such that different techniques and/or ciphers may be used for different stages along the communication path. For example, a first encryption technique or cipher may be used for the data transmissions aboard ship 12, a second encryption technique or cipher may be used for data transmissions between ship 12 and satellite 200, a third encryption technique or cipher may be used for data transmissions between satellite 200 and base station 300, and a fourth encryption technique or cipher may be used for data transmissions between base station 300 and terminal 310 through network 320. For example, system 10 may utilize one or more of RSA, CAST, TEA, ECS, DES/3DES, BLOWFISH, IDEA, or MD5 encryption algorithms. In certain embodiments, communicated data may be encrypted at multiple layers. In certain embodiments, Point-to-Point Tunneling Protocol (PPTP), Layer 2 Tunneling Protocol (L2TP), or other appropriate protocols may be used.

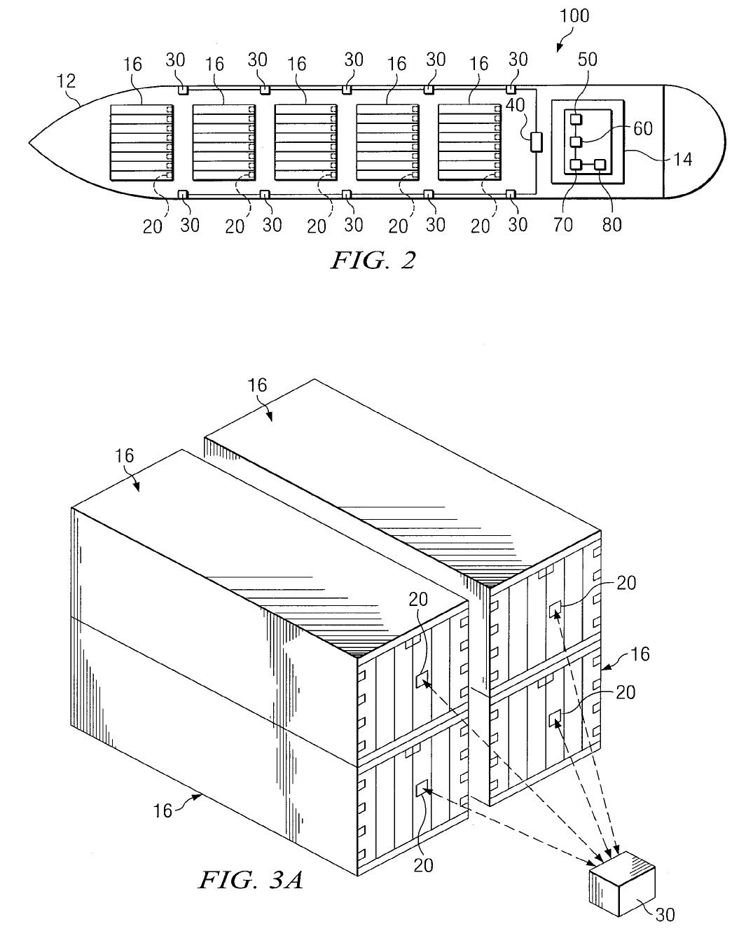

FIG. 2 illustrates an example cargo ship 12 carrying a plurality of cargo containers 16 and including components of an example cargo container monitoring system 10. In the embodiment shown, a single tag 20 is associated with each cargo container 16 on ship 12. In certain embodiments, one or more of cargo containers 16 may be associated with a plurality of tags 20. Similarly, in certain embodiments, only particular cargo containers 16 may be associated with one or more tags 20. Tags 20 may communicate with one or more of the onboard components of cargo container monitoring system 10.

In the embodiment shown in FIG. 2, onboard components, indicated generally at 100, include multiple data loggers 30, gateway 40, access point 50, controller 60, antenna 70, and tracking and stability module 80. Although certain embodiments may include all of the onboard components described and illustrated in FIG. 2, alternative embodiments may include more or less components. For example, certain embodiments may include multiple gateways 40, certain embodiments may use combination devices that provide the functionality of both gateway 40 and data logger 30, certain embodiments may utilize wireline connections to controller 60 and may not include access point 50, and/or certain embodiments may use multiple access points 50.

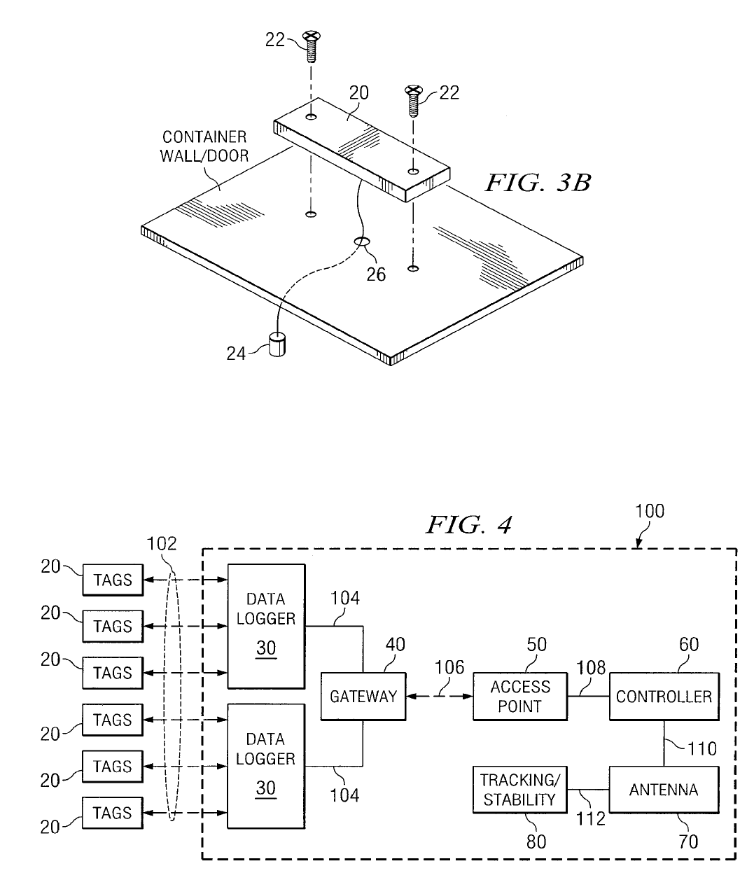

Data loggers 30 may be positioned permanently or removably in any appropriate position aboard ship 12 to communicate with tags 20. As shown in FIG. 2, in certain embodiments, cargo containers 16 may be arranged in one or more rows which may be spaced apart to provide access to each cargo container 16 while cargo containers 16 are being carried aboard ship 12. In these embodiments, one or more data loggers 30 may be permanently or removably positioned on the cargo deck of ship 12 in the space between two or more rows of cargo containers 16 and/or along the sides of ship 12 near the rows of cargo containers 16. In certain embodiments, data loggers 30 may be positioned such that, for each tag 20, a direct line-of-sight may be maintained with at least one data logger 30 or at least one antenna of a data logger 30. For example, as shown in FIG. 3A, tags 20 may be positioned on the exposed doors of cargo containers 16 and a data logger 30 may be positioned to maintain a direct line-of-sight with tags 20.

As shown in FIG. 3B, tag 20 may be mounted to an exterior surface of cargo container 16 such as a portion of the container door. In certain embodiments, tag 20 may be attached to cargo container 16 via one or more couplers 22. In a particular embodiment, coupler 22 may be a threaded screw and/or bolt. In alternative embodiments, coupler 22 may be a rivet or any other appropriate coupling device. In certain embodiments, tag 20 may be attached to an exterior surface of cargo container 16 and may utilize a sensor 24 that may be positioned inside cargo container 16. In certain embodiments, tag 20 may communicate with sensor 24 wirelessly or through the use of a wire and/or cable extending through an opening 26 in cargo container 16. In a particular embodiment, opening 26 may be covered and/or sealed by tag 20 when tag 20 is attached to cargo container 16. In embodiments in which tag 20 communicates with sensor 24 wirelessly, such communication may be through IEEE 802.11, BLUETOOTH, and/or any other appropriate wireless protocol. In a particular embodiment, tag 20 may actively collect data from one or more sensors and/or one or more passive RF ID tags within cargo container 16.

One or more gateways 40 may be permanently or removably positioned on ship 12 to communicate with one or more data loggers 30. For example, in a particular embodiment, two gateways 40 may be positioned on ship 12 with one gateway 40 positioned forward of tower 14 and the other gateway 40 positioned aft of tower 14. In certain embodiments, as shown in FIG. 2, access point 50, controller 60, and antenna 70 may be positioned on or near tower 14.

FIG. 4 illustrates an example data flow between a plurality of tags 20 and onboard components 100. In the embodiment shown, the plurality of tags 20 communicate via wireless communication signals 102 with data loggers 30. Data loggers 30 are coupled to gateway 40, which communicates wirelessly with access point 50. Access point 50 is coupled to controller 60, which is coupled to antenna 70.

Tracking and stability module 80 is also coupled to antenna 70. Although FIG. 4 illustrates an example data flow, alternative data flows may be utilized. For example, data loggers 30 may be configured in serial, in parallel, or in a combination of both. As another example, tracking and stability module may couple to controller 60 and only indirectly couple to antenna 70 through controller 60.

Data logger 30, as illustrated in FIG. 4, receives data from a plurality of tags 20 through wireless communication signals 102. Data logger 30 may store data received from a plurality of tags 20 and/or transmit received data to gateway 40. Gateway 40 may collect and store data received from one or more data loggers 30 and transmit the data to access point 50 via wireless communication signals 106.

Wireless communication signals 102 and 106 may represent any appropriate wireless frequency and/or protocol. For example, in a particular embodiment, wireless communication signals 102 and 106 may represent an IEEE 802.11 standard radio frequency protocol or an ISO 18000-7 standard protocol. In certain embodiments, wireless communication signals 102 and 106 may transmit at frequencies in the UHF band. Wireless communication signals 102 and 106 mayor may not utilize the same frequencies and/or protocols.

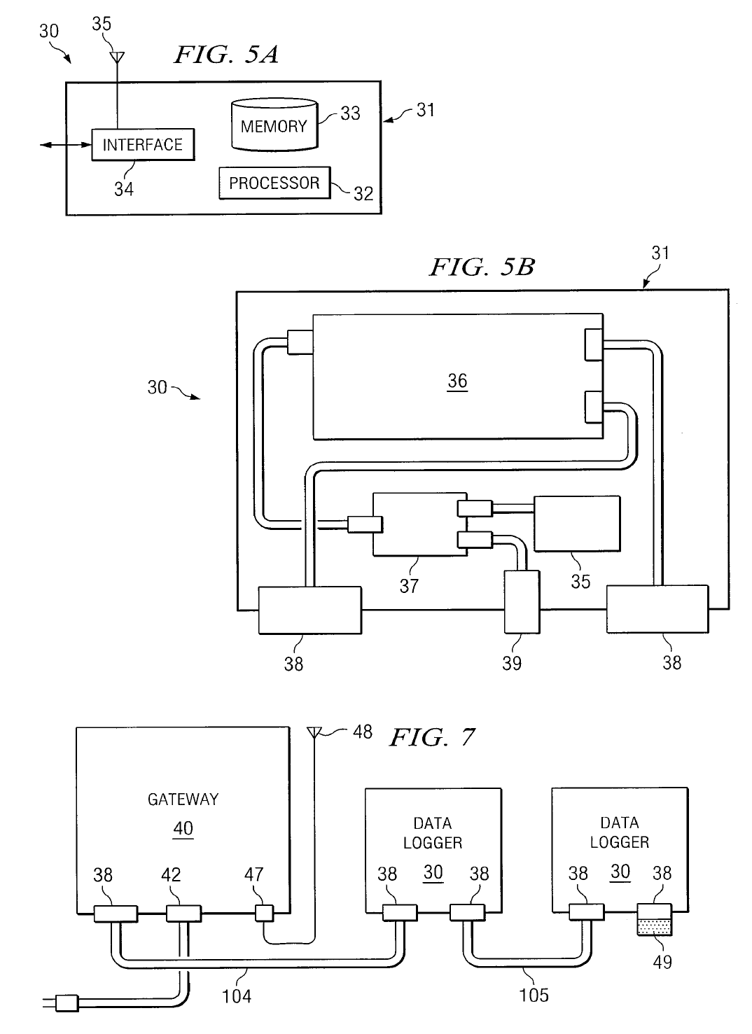

FIG. 5A illustrates a block diagram of an example data logger 30. In the embodiment shown, data logger 30 includes case 31, processor 32, memory 33, interface 34, and antenna 35. These components operate together to collect data from tags 20. In certain embodiments, data logger 30 may collect data from tags 20 on a periodic and/or event-driven basis. For example, data logger 30 may collect data from tag 20 at daily, hourly, or randomly-generated intervals. In another example, data logger 30 may collect data from tag 20 in response to a user initiated event and/or in response to a triggering event detected by tag 20. In certain embodiments, the transmission of data from tag 20 may be actively driven by logic within tag 20, passively driven in response to a request for data from data logger 30 (or other data collection device), and/or some combination of both.

Case 31 may provide a protective housing for the components of data logger 30. In certain embodiments, case 31 may represent a substantially weatherproof housing to protect the components of data logger 30 from dust, moisture, sunlight, and/or other potentially damaging elements. Case 31 may be formed from any appropriate material or materials. In a particular embodiment, all or a portion of case 31 may be formed from a weather resistant plastic, such as acrylonitrile ethylene styrene (AES) or acrylonitrile styrene acrylate (ASA). In certain embodiments, all or a portion of case 31 may be formed from a metal, such as aluminum, or an alloy thereof.

Processor 32 controls the operation and administration of the elements within data logger 30 by processing information received from interface 34 and memory 33. Processor 32 includes any hardware and/or controlling logic elements operable to control and process information. For example, processor 32 may be a logic device, a micro controller, and/or any other suitable processing device or devices, Memory 33 stores, either permanently or temporarily, data and other information for processing by processor 32 and communication using interface 34. Memory 33 includes anyone or a combination of volatile or non-volatile devices suitable for storing information. Memory 33 may store, among other things, data collected from one or more tags 20. This data may include, for example, identification information, status information, and/or information collected from one or more sensors associated with tag 20.

Interface 34 communicates information to and receives information from devices coupled to data logger 30. For example, as shown in FIG. 5A, interface 34 may couple to antenna 35 to transmit and/or receive information wirelessly. In certain embodiments, interface 34 may couple to a network, gateway 40, controller 60, one or more other data loggers 30, etc.

Antenna 35 receives and/or transmits wireless communication signals from and/or to tags 20, gateway 40, and/or other wireless devices. In certain embodiments, as shown in FIG. 5A, antenna 35 may be mounted on the exterior of case 31 or otherwise positioned exterior to case 31. In alternative embodiments, antenna 35 may be positioned inside case 31. Interface 34 may also couple to one or more other antennas 35. In a particular embodiment, data logger 30 may be coupled to a plurality of antennas 35 distributed to provide greater reception and/or to allow for triangulation of tags 20 based on the power received at each antenna 35.

FIG. 5B illustrates a schematic drawing of an example data logger 30 incorporating an i-PORT UHF interrogator available from IDENTEC SOLUTIONS INC., of Addison, Tex. In the embodiment shown, interrogator 36 is coupled to RE splitter 37 and to panel mount RJ 45 connectors 38. RF splitter 37 couples to antenna 35 and to an SMA connector 39. Antenna 35 may be mounted on the exterior of case 31 or in any other appropriate location. Interrogator 36 is coupled to connectors 38 via CAT 5 ethernet cable. RF splitter 37 is coupled to interrogator 36 and to connector 39 via appropriate antenna cables. In the configuration shown in FIG. 5B, the components of data logger 30 may receive power through connector 38 and multiple data loggers 30 may be connected in a daisy-chain configuration using, for example, CAT 5 cables between connector 38 of one data logger and connector 38 of another data logger. Similarly, connector 39 may be used to couple data logger 30 to one or more external antennas. An example external antenna may include an I-A9185 UHF antenna, available from IDENTEC SOLUTIONS INC., of Addison, Tex.

Gateway 40 represents a component configured to wirelessly transmit cargo data collected from a plurality of tags 20. In certain embodiments, gateway 40 may receive data collected by one or more data loggers 30 from the plurality of tags 20. Gateway 40 may be coupled to multiple data loggers 30 in a serial and/or parallel coupling arrangement. In a particular embodiment, gateway 40 may be coupled to data logger 30 via a wireless or wireline network. In certain embodiments, gateway 40 may include a case, a processor, memory, an interface, and a battery or other appropriate power supply. In certain embodiments, gateway 40 may include an antenna and/or may be coupled to an external antenna. In certain embodiments, the functions of data logger 30 and gateway 40 may be combined in a single device.

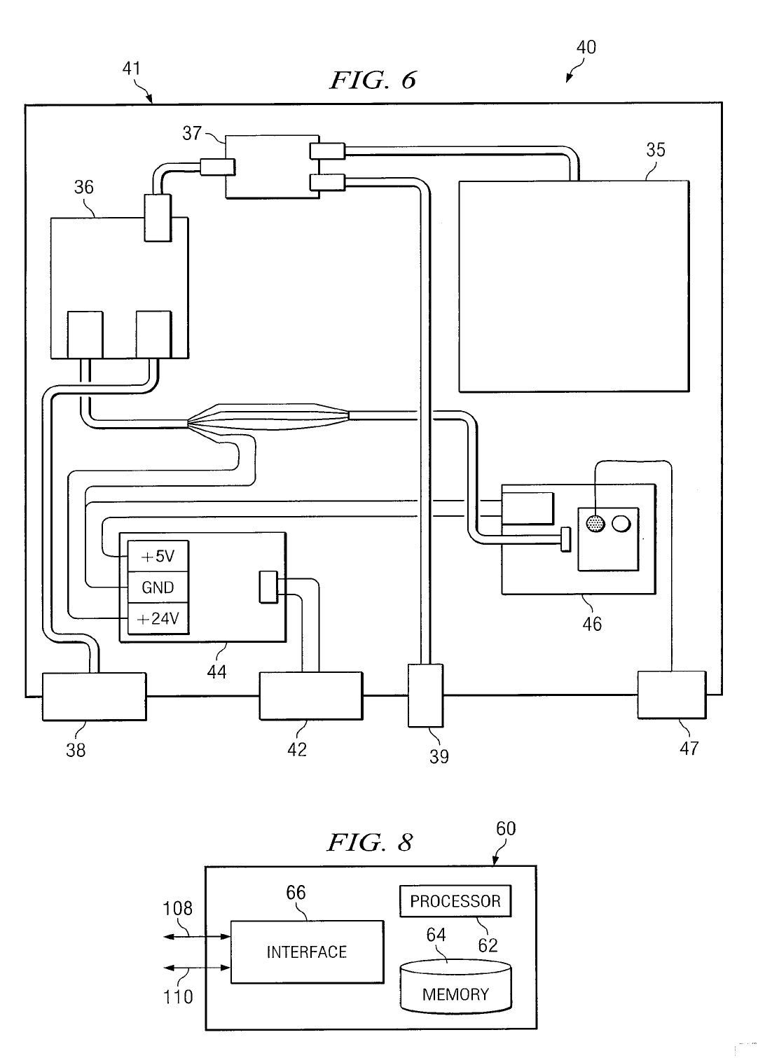

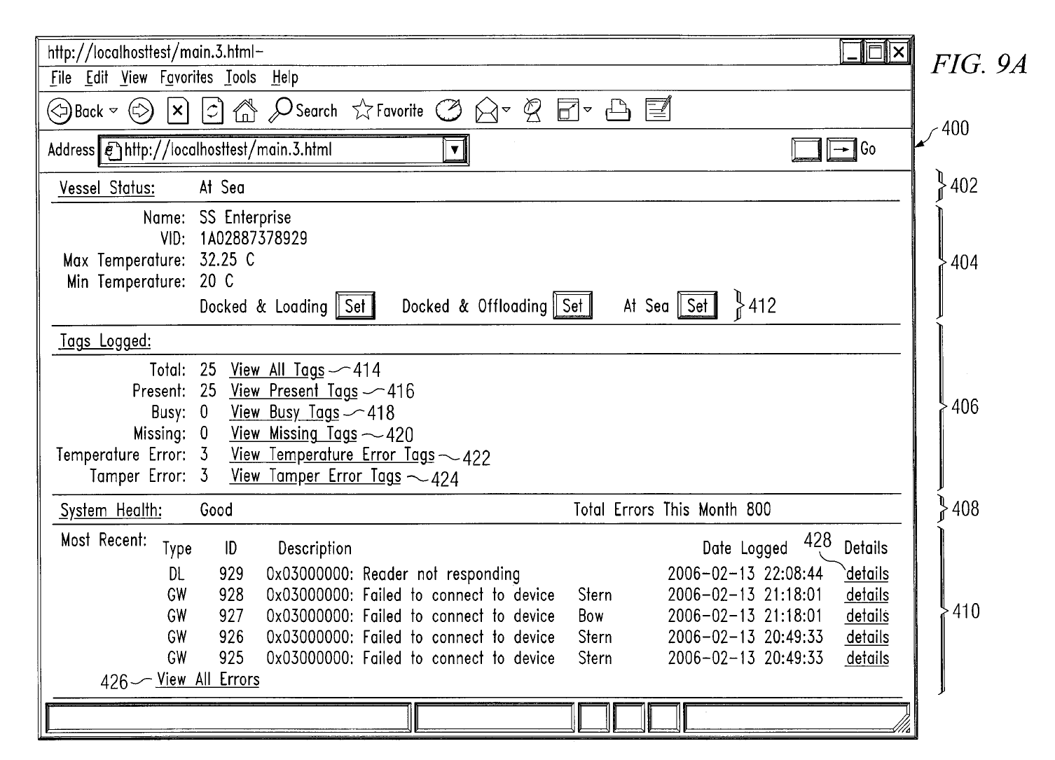

FIG. 6 illustrates a schematic drawing of an example gateway 40 including components to provide the functionality of both gateway 40 and data logger 30. In the embodiment shown, gateway 40 includes case 41, antenna 35, interrogator 36, RF splitter 37, panel mount RJ 45 connector 38, SMA connector 39, panel mount power jack 42, power supply 44, Airborne Direct (AbD) serial bridge 46, and panel mount N-Female connector 47.

Case 41 may provide a protective housing for the components of gateway 40. In certain embodiments, case 41 may represent a substantially weatherproof housing to protect the components of gateway 40 from dust, moisture, sunlight, and/or other potentially damaging elements. Case 41 may be formed from any appropriate material or materials. In a particular embodiment, all or a portion of case 41 may be formed from a weather resistant plastic, such as acrylonitrile Ethylene Styrene (AES) or acrylonitrile styrene acrylate (ASA). In certain embodiments, all or a portion of case 31 may be formed from a metal, such as aluminum, or an alloy thereof.

In certain embodiments, interrogator 36 may control the operation of gateway 40. For example, interrogator 40 may include logic configured to control the collection, storage, and/or transmission of cargo container status information. In 10 particular embodiments interrogator 36 may include a processor and a memory.

In certain embodiments, connector 47 may connect to an external antenna, such as a 2.4 GHz WLAN antenna. Connector 42 may couple to a 120 volt AC power source. Connector 39 may couple to one or more external antennas to receive data from one or more tags 20. Connector 38 may couple to another gateway 40 and/or data logger 30.

FIG. 7 illustrates an example configuration of elements within cargo container monitoring system 10. In the embodiment shown, a single power source coupled to connector 42 may be utilized to provide power for gateway 40 and one or more data loggers 30 using a daisy-chain type configuration. Gateway 40 couples to a first data logger 30 via cable 104 and the first data logger 30 is coupled to a second data logger 30 via cable 105. In a particular embodiment, both cables 104 and 105 may represent an IP65 double-ended CAT 5 cordset. In this configuration, the last data logger 30 in the daisy-chain series may utilize an IP65 endcap 49 coupled to connector 38. In certain embodiments, this type of configuration may simplify the installation of a plurality of data loggers 30 on or near the cargo deck of ship 12 by providing distributed coverage without the need for numerous distributed power sources throughout ship 12. In addition, in certain embodiments, this type of configuration may allow for quick and easy replacement of damaged components by simply uncoupling the damaged component, replacing it with a new or repaired component, and re-establishing the few necessary connections.

Access point 50 may represent communications equipment, including hardware and any appropriate controlling logic, for providing wireless access to controller 60. In particular embodiments, access point 50 may include a radiofrequency transceiver capable of generating and converting radio-frequency signals and an antenna capable of transmitting radio-frequency signals to and receiving radiofrequency signals from gateway 40. In certain embodiments, access point 50 may include an antenna capable of transmitting radio frequency signals to and receiving radio frequency signals from a portable wireless device. In certain embodiments, access point 50 may be configured to utilize the IEEE 802.11 wireless communication protocol. In a particular embodiment, access point 50 may represent an outdoor high power access point operating, for example, at 20 dBm. In certain embodiments, access point 50 may utilize Wi-Fi Protected Access (WP A) link-level encryption to prevent unauthorized access.

Controller 60 represents an electronic device (or group of devices) capable of controlling the collection of data from the plurality of data loggers 30 on ship 12. FIG. 8 illustrates a block diagram of an example controller 60. In the embodiment shown, controller 60 includes processor 62, memory 64, and interface 66. In certain embodiments, controller 60 may include a mouse, a touch pad, a keyboard, or other input device. In certain embodiments, controller 60 may include a monitor or other form of display device. Controller 60 may include logic to receive, aggregate, store, organize, and/or display all or a portion of the data collected from tags 20. In certain embodiments, controller 60 may include logic to generate and receive user interactions from a graphical user interface.

Processor 62 controls the operation and administration of the elements within controller 60 by processing information received from interface 66 and memory 64. Processor 62 includes any hardware and/or controlling logic elements operable to control and process information. For example, processor 62 may be a logic device, a micro controller, and/or any other suitable processing device or devices.

Memory 64 stores, either permanently or temporarily, data and other information for processing by processor 62 and communication using interface 66. Memory 64 includes anyone or a combination of volatile or non-volatile devices suitable for storing information. Memory 64 may store, among other things, data collected from one or more data loggers 30.

Interface 66 represents one or more components operable to communicate information to and receive information from devices coupled to controller 60. For example, as shown in FIG. 8, interface 66 may couple to access point 50 via communication path 108 and antenna 70 via communication path 110. In certain embodiments, interface 66 may couple to one or more input and/or output devices.

In certain embodiments, controller 60 may serve as the core management component of onboard components 100. Controller 60 may provide logic necessary for interrogating data loggers 30, monitoring for one or more triggering events at tags 20, compiling this collected data, and/or transforming this data into an organized arrangement of information. In certain embodiments, controller 60 may include logic to generate a graphical user interface to display all or a portion of this information. In certain embodiments, controller 60 may include logic necessary to translate the collected information for an Application Specific Interface with one or more proprietary ship board systems.

Antenna 70 represents a device or group of devices capable of communicating with one or more satellites 200. In: various embodiments, antenna 70 may be capable of communicating using one or more of code division multiple access (CDMA), frequency division multiple access (FDMA), and time division multiple access (TDMA) technologies. In certain embodiments, antenna 70 may include a transceiver capable of generating and converting communications signals and a parabolic dish capable of transmitting communications signals to and receiving communications signals from satellite 200.

Although in various embodiments antenna 70 may be configured to transmit and receive any appropriate communications signals, in certain embodiments, antenna 70 may be configured to transmit and receive communications signals in the microwave band. For example, antenna 70 may be configured to transmit and receive communications signals in the range from 300 MHz to 30 GHz. In certain embodiments, antenna 70 may be configured to transmit and receive communications signals in one or more of the L, C, X, Ku, Ka, and S bands.

In certain embodiments, antenna 70 may be configured to transmit communications signals at a frequency in the range from 1600 MHz to 1700 MHz, and more particularly in the range from 1610 MHz to 1626.5 or 1626.5 MHz to 1660.5 MHz. As one alternative, antenna 70 may be configured to transmit communications signals at a frequency in the range from 2400 MHz to 2500 MHz, and more particularly in the range from 2480 MHz to 2500 MHz.

In certain embodiments, antenna 70 may be configured to receive communications signals at a frequency in the range from 1500 MHz to 1600 MHz, and more particularly in the range from 1525 MHz to 1559 MHz. As one alternative, antenna 70 may be configured to receive communications signals at frequencies in the range from 1600 MHz to 1700 MHz, and more particularly in the range from 1610 MHz to 1626.5 MHz.

In certain embodiments, antenna 70 may include and/or operate together with a suitable tracking and stability module 80. Tracking and stability module 80 represents a device, or collection of devices, configured to assist one or more antennas in maintaining proper alignment with one or more satellites 200. In certain embodiments, a suitable tracking and stability module 80 may include a gyro controlled platform to provide three-axis yaw, pitch, and roll rates. For example, antenna 70 may include and/or operate together with a WF205 system available from WiFi WIRELESS, INC., of Aliso Viejo, Calif.

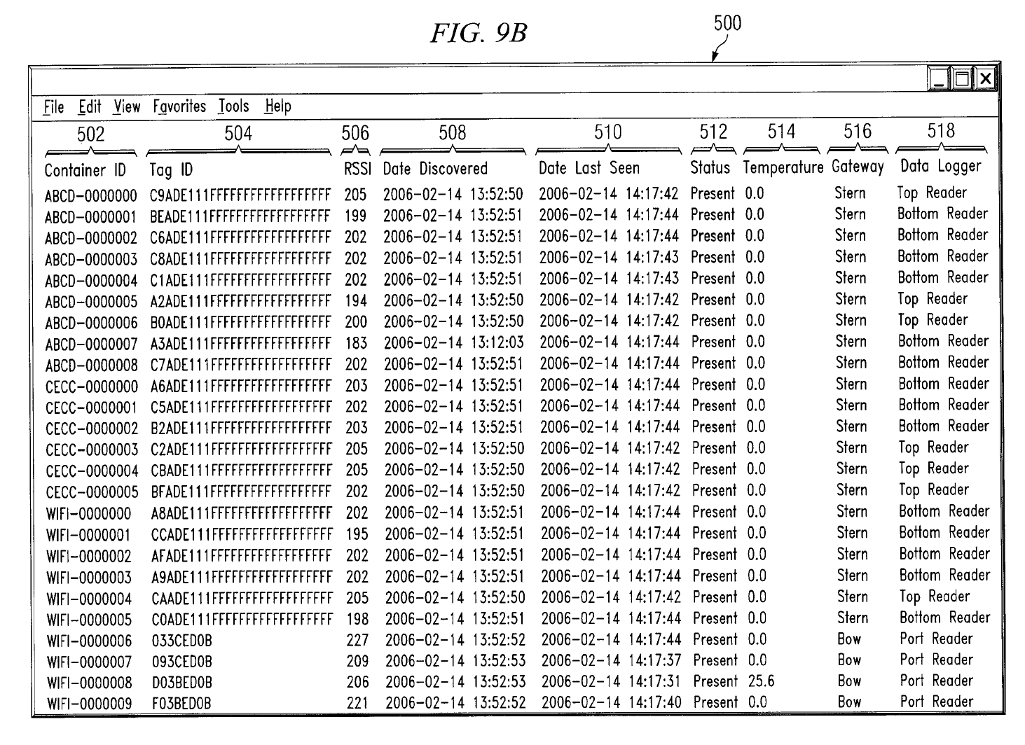

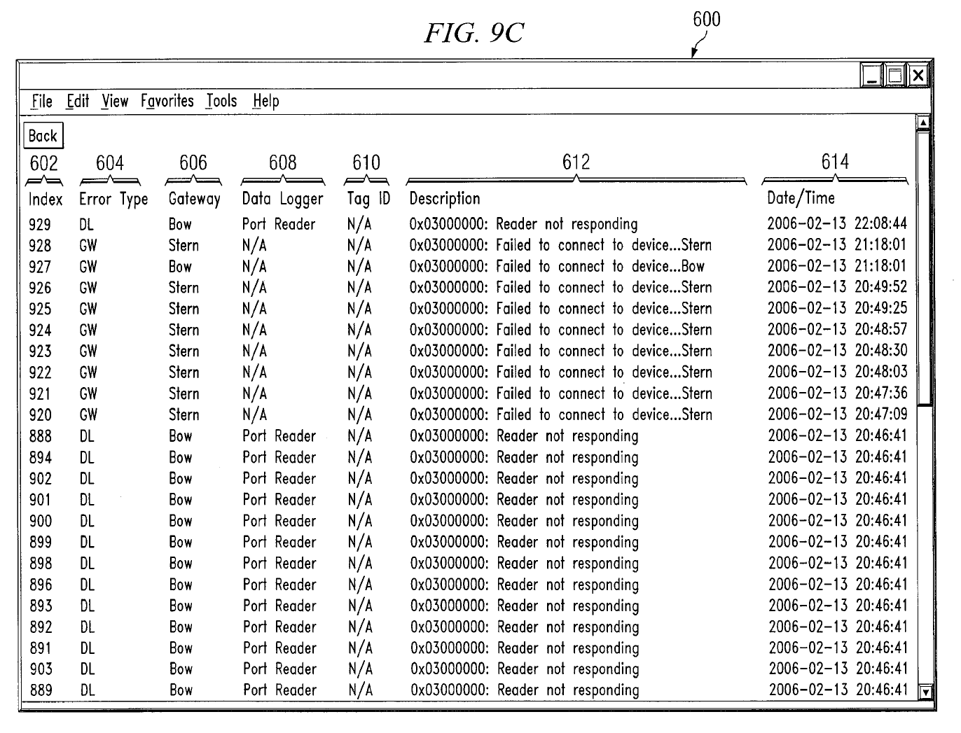

FIGS. 9A through 9C illustrate example graphical user interfaces (GUI) for use with cargo container monitoring system 10. In the embodiment shown in FIG. 9A, GUI 400 includes vessel status 402, vessel data 404, tag data 406, system health 408, and error data 410.

Vessel status 402 may indicate the current operating status of onboard components 100. Example of vessel status 402 categories may include “docked and loading,” “docked and unloading,” and/or “at sea.” Docked andJoading status may indicate that the system has stopped logging cargo container information to allow for the loading of new cargo containers 16 onto ship 12. Docked and unloading status may indicate that the system has stopped logging container information to allow for the unloading of cargo containers 16 from ship 12. At sea status may indicate that the system will collect information from tags 20 found on ship 12 and continue to log their presence and other information for the duration of the voyage.

Vessel data 404 may include a vessel name, a vessel identifier (VID), a maximum temperature, and a minimum temperature. The vessel name may be the human readable name of ship 12. The vessel identifier may be a unique alphanumeric identifier associated with ship 12. The maximum temperature may be a temperature setting for the upper bound for normal tag monitoring; readings above this temperature value may result in a temperature error. Minimum temperature may represent a lower bound for normal temperature tag monitoring; readings below this value may indicate a temperature error.

Tag data 406 may provide a summary of information for tags 20 on ship 12. For example, tag data 406 may identify the total number of tags 20 identified since the vessel status was set to “at sea,” the total number of tags 20 currently being monitored by the system, the total number of tags currently being polled, the total number of tags previously identified in the system since the vessel status was set to “at sea” (but no longer accounted for as either present or busy), the number of tags that have registered a temperature error, and the number of tags that have registered a breach or tamper error. In alternative embodiments, tag data 406 may include any appropriate status information for tags 20.

System health 408 may include information that provides a summary of the status of onboard components 100. For example, system health 408 may include a calculated number of errors registered over a particular period of time. As another example, system health 408 may include a quality category such as “good,” “OK,” or “poor.” In a particular embodiment, a “good” status may indicate that there have been no errors for the current day, an “OK” status may indicate that one to nine errors have occurred in the current day, and a poor status may indicate that more than nine errors have occurred in the current day.

Error data 410 may include summary information for registered system errors. Error data 410 may include the type of system error, the ID of the device having an error, a code and description of the error, the date that the error was registered, and/or any other appropriate error information.

In certain embodiments, GUI 400 may include one or more controls and/or links to direct a user to one or more additional graphical user interfaces or to change the display of OUI 400. For example, GUI 400 may include a “view all tags” link 414, a “view present tags” link 416, a “view busy tags” link 418, a “view missing tags” link 420, a “view temperature error tags” link 422, a “view tamper error tags” 424, a “view all errors” link 426, and multiple “error detail” links 428. In certain embodiments, GUI 400 may include one or more controls to register a selection or input from a user such as vessel status controls 412, which may be used to establish the current status of onboard components 100 for ship 12.

In certain embodiments, a user may control the operation of onboard components 100 through the use of controller 60, and in particular embodiments through the use of a graphical user interface such as GUI 400. When ship 12 is at port being loaded, onboard components 100 may be set such that information is not collected from tags 20 by data loggers 30. In this setting, information mayor may not be collected by a separate device, such as a handheld device operated by a user. While ship 12 is at port, or at another time prior to departure, tags 20 may be activated by a wireless device, a proximity device, or other suitable method. In certain embodiments, upon departure or just prior to departure, a user may set onboard components 100 to poll tags 20 throughout ship 12 to obtain status information for the cargo containers 16 aboard ship 12. This initial data collection may be performed by actively polling tags 20 by transmitting a wireless signal including a request for status information from tags 20. In certain embodiments, such polling may be done throughout ship 12 at substantially the same time, or may be done in groups based on gateway 40, data logger 30, or other criteria. In certain embodiments, data collection may be performed passively by monitoring for tags 20 to transmit status information at a periodic interval set for each tag 20. In certain embodiments, following an initial active data collection, data loggers 30 may continue to monitor for status information transmitted by tags 20 and/or may periodically poll tags 20 for status information. In certain embodiments, data loggers 30 may poll all or a particular portion of tags 20 in response to a user command. In certain embodiments, upon arriving at a destination port or just prior to arriving at a destination port, a user may set onboard components 100 such that data loggers 30 poll tags 20 for a final update to the cargo container status information. Although certain settings have been described herein, in alternative embodiments any appropriate settings or combination of settings may be utilized to satisfy particular needs. In addition, although certain activities have been described herein as being performed by a user, in certain embodiments one or more of these activities may be automated.

FIG. 9B illustrates an example GUI 500 for use with cargo container monitoring system 10. In certain embodiments, GUI 500 may display a summary of collected data for all tags 20 on ship 12. In a particular embodiment, GUI 500 may be displayed in response to a user selection of the “view all tags” link 414 from GUI 400. In the embodiment shown, GUI 500 includes container ID 502, tag ID 504, relative signal strength (RSSI) 506, date discovered 508, date last seen 510, status 512, temperature 514, gateway 516, and data logger 518.

Container ID 502 may include names or alphanumeric identifiers associated with all or a portion of the cargo containers 16 loaded on ship 12. Tag ID 504 may include unique or substantially unique identifiers associated with all or a portion of the tags 20 located on ship 12. RSSI 506 may include a quantitative and/or qualitative value indicating the relative wireless signal strength of each identified tag 20. Date discovered 508 may include information identifying the date and/or time that the identified tag 20 was first detected by onboard components 100. Date last seen 510 may include the date and/or time that the identified tag 20 was most recently detected by onboard components 100. Status 512 may include information that identifies the current system status for the identified tag 20. In certain embodiments, example categories for status 512 may include “present,” “missing,” and/or “busy.” Temperature 514 may include the current or most recently collected temperature sensed by the identified tag 20. Gateway 516 may include the name of the gateway 40 through which data associated with the identified tag 20 is being transmitted. Data logger 518 may include an identifier for the particular data logger 30 through which data associated with the identified tag 20 is being transferred. In certain embodiments, the information displayed by GUI 500 may be selectable, sortable, and/or linkable to additional graphical user interfaces and/or information.

FIG. 9C illustrates an example GUI 600 for use with cargo container monitoring system 10. In certain embodiments, GUI 600 may be utilized to display a list of the errors registered by onboard components 100 over a period of time. In certain embodiments, GUI 600 may be displayed in response to a user selection of “view all errors” link 426. In the embodiment shown, GUI 600 includes index 602, error type 604, gateway 606, data logger 608, tag ID 610, description 612, and date/time 614.

Index 602 may include an incrementing index of errors registered by onboard components 100. Error type 604 may include a categorical type of error registered by onboard components 100. For example, error type 604 may include an indication of the device type associated with the identified error. Gateway 606 may include an indication of the particular gateway 40 associated with the identified error. Data logger 608 may include an identification of the particular data logger 30 associated with the identified error. Tag ID 610 may include an identifier for the particular tag 20 associated with the identified error. Description 612 may include a specific error type and/or description of a particular error type for the identified error. Date/time 614 may include the date and/or time that the error was first registered and/or identified. In certain embodiments, the information displayed by GUI 600 may be selectable, sortable, and/or linkable to additional graphical user interfaces and/or information.

In certain embodiments, controller 60 and/or terminal 310 may represent a general purpose computer adapted to execute any of the well-known WINDOWS, OS2, UNIX, MAC-OS, and LINUX operating systems or other operating systems. Such a general purpose computer may include a processor, a random access memory (RAM), a read only memory (ROM), a mouse or touch pad, a keyboard and inputoutput devices such as a printer, disk drives, a display and a communications link. In alternative embodiments, such a general purpose computer may include more, less, or other component parts. Embodiments of the invention may include programs to be stored in the RAM, ROM, or the disk drives and may be executed by the processor. The communications link may be connected to a computer network or a variety of other communications platforms. The disk drives may include a variety of types of storage media such as, for example, floppy disk drives, hard disk drives, CD ROM drives, Dvn ROM drives, flash drives, magnetic tape drives, or other suitable storage media.

In certain embodiments of the invention, particular components may be utilized to transmit wireless signals at particular frequencies and/or according to particular protocols. The particular frequencies and/or protocols may be selected based on their performance characteristics in the environment in which the components are expected to operate and/or based upon the functions they are expected to provide. In certain embodiments, the selection of particular characteristics for wireless communications between tag 20 and data logger 20 (or gateway 40) may be selected to reduce the power required to transmit these signals and/or to ensure sufficient transmission range for these signals. For example, in certain embodiments, wireless communications signals between tags 20 and data logger 30 (or gateway 40) may utilize frequencies in the UHF band, and more particularly frequencies of approximately 868 MHz or 915 MHz over a range of approximately 300 feet using low power consumption to enable tags 20 to operate on battery power and transmit signals to components located on or near a cargo deck of ship 12.

Several embodiments of the invention may include logic which may be contained within a medium. This logic may comprise computer software executable on a computer. The medium may include a RAM, ROM, or disk drive. In other embodiments, the logic may be contained within hardware configurations or a combination of software and hardware configurations. The logic may also be embedded within any other suitable medium without departing from the scope of the invention.

Although the present invention has been described in several embodiments, a plentitude of changes and modifications may be suggested to one skilled in the art, and it is intended that the present invention encompass such changes and modifications as fall within the present appended claims.

What is claimed is:

1. A cargo container monitoring system, comprising components located on a cargo ship for collecting cargo container status information for a plurality of cargo containers, the components comprising:
a. at least one combination data logger and gateway device, the combination device comprising:
b. a first antenna configured to receive first wireless communications signals transmitted by a plurality of tags at a first frequency, each tag being associated with a particular one of the cargo containers, the first wireless communications signals received from each tag including cargo container status information for the associated cargo container; and
c. a second antenna configured to transmit second wireless communications signals to an access point at a second frequency, the second wireless communications signals including the cargo container status information received from the plurality of tags;
wherein the first frequency is different from the second frequency.

2. The system of claim 1, wherein:
the combination data logger and gateway device further comprises a case; and
the first antenna and the second antenna are disposed within the case.

3. The system of claim 1, wherein the components further comprise:
a. a third antenna configured to transmit communications signals to an orbiting satellite; and
b. a tracking and stability device configured to enable the third antenna to maintain proper alignment with the orbiting satellite.

4. The system of claim 3, wherein the third antenna is configured to transmit communications signals to an orbiting satellite at any frequency within the range of satellite frequencies available to a ship-owner.

5. The system of claim 1, wherein the combination data logger and gateway device is configured to:
a. poll a tag by transmitting a request to the tag and receiving communications signals generated and transmitted by the tag in response to the tag receiving the request; and
b. receive communications signals generated and transmitted by a tag in response to the tag detecting a triggering event.

6. The system of claim 5, wherein the triggering event comprises at least one of the following events:
a. a breach in a cargo container;
b. a temperature measurement being outside of an established range;
c. a detection of the presence of a particular chemical; and
d. a radioactivity measurement being above an established limit.

7. The system of claim 1, wherein the first frequency is in the UHF band.

8. The system of claim 1, wherein the first frequency is approximately 915 MHz.

9. The system of claim 1, wherein the second frequency is approximately 2.4 GHz.

10. The system of claim 1, wherein the first antenna is further configured to transmit third wireless communications signals to the plurality of tags at the first frequency.

11. The system of claim 1, wherein the combination data logger and gateway device further comprises:
a. a first connector configured to couple to a power source; and
b. a second connector configured to couple to a second device to communicatively couple to the second device and to provide power to the second device.

12. The system of claim 1, wherein the cargo container status information comprises:
a. at least one selected from the group comprising a tag identifier and a cargo container identifier; and
b. at least one selected from the group comprising an indication of a temperature measurement, an indication of the presence of a particular chemical, an indication of whether the cargo container has been breached, and an indication of a radioactivity measurement.

13. A cargo container monitoring device for collecting cargo container status information for a plurality of cargo containers aboard a cargo ship, comprising:
a. a first antenna configured to receive first wireless communications signals transmitted by a plurality of tags at a first frequency, each tag being associated with a particular one of the cargo containers, the first wireless communications signals received from each tag including cargo container status information for the associated cargo container;
b. a memory configured to store the cargo container status information received from the plurality of tags;
c. a second antenna configured to transmit second wireless communications signals to an access point at a second frequency, the second wireless communications signals including the cargo container status information received from the plurality of tags; and
d. a processor configured to control the operation of the device;
wherein the first frequency is different from the second frequency.

14. The device of claim 13, wherein the first frequency is in the UHF band.

15. The device of claim 13, wherein the first frequency is approximately 915 MHz.

16. The device of claim 13, wherein the second frequency is approximately 2.4 GHz

17. The device of claim 13, wherein the first antenna is further configured to transmit third wireless communications signals to the plurality of tags at the first frequency.

18. The device of claim 13, further comprising:
a. a first connector configured to couple to a power source; and
b. a second connector configured to couple to a second cargo container monitoring device to communicatively couple to the second device and to provide power to the second device.

19. The device of claim 13, wherein the cargo container status information comprises:
a. at least one selected from the group comprising a tag identifier and a cargo container identifier; and
b. at least one selected from the group comprising an indication of a temperature measurement, an indication of the presence of a particular chemical, an indication of whether the cargo container has been breached, and an indication of a radioactivity measurement.

20. A method for monitoring a plurality of cargo containers, comprising:
a. receiving at a terminal, cargo container status information for a plurality of cargo containers aboard a cargo ship, the cargo container status information having been collected by a combination data logger and gateway device, the combination device comprising:
i. a first antenna configured to receive first wireless communications signals transmitted by a plurality of tags at a first frequency, each tag being associated with a particular one of the plurality of cargo containers, the first wireless communications signals received from each tag including cargo container status information for the associated cargo container; and
ii. a second antenna configured to transmit second wireless communications signals to an access point at a second frequency, the second wireless communications signals including the cargo container status information received from the plurality of tags;
wherein the first frequency is different from the second frequency; and
b. displaying at the terminal, a graphical user interface including at least a portion of the cargo container status information for the plurality of cargo containers aboard the cargo ship.
